(19) United States
(12) Patent Application Publication
(10) Pub. No.: US 2001/0039518 A1
(43) Pub. Date: Nov. 8, 2001

(54) Commodity retrieval method

(76) Inventors: Hiroshi Ishizuka, Kawasaki (JP); Keiichirou Nakafuji, Kawasaki (JP); Tomoichiro Hayashi, Kawasaki (JP); Naoki Kazegoshi, Kawasaki (JP)

Correspondence Address: STAAS & HALSEY LLP, 700 11TH STREET, NW, SUITE 500, WASHINGTON, DC, 20001, US

(21) Appl. No.: 09/759,534

(22) Filed: Jan. 16, 2001

(30) Foreign Application Priority Data
Apr. 7, 2000 (JP) 2000-106560

(51) Int. Cl. G06F 17/60

(52) U.S. Cl. 705/27

(57) ABSTRACT

In a commodity sale via Internet, commodities to be sold are retrieved based on a object of use of the commodity. The commodities meeting retrieval conditions are displayed at Internet terminal. Thus, it is easy for a user to select the commodity. Furthermore, in the case where the user selects an accessory commodity which is connected to a main unit commodity, the accessory commodity which is confirmed to operate with respect to the main unit commodity is displayed in Internet terminal. Thus, it becomes easy for the user to select the commodity. Furthermore, it is feasible for the user to purchase erroneously the accessory commodity which is not adapted for the main unit commodity. Furthermore, the commodity for sale is retrieved based on a specification of the commodity. This also makes it easy to select the commodity.

### BACKGROUND OF THE INVENTION

1. Field of the Invention

The present invention relates generally to a commodity retrieval method for retrieving a desired commodity from a plurality of commodities, and more particularly to a commodity retrieval method in a commodity sale transaction by way of Internet.

2. Description of the Related Arts

Commodity sales utilizing Internet are rapidly prevailing. A user connects a personal computer to Internet via a communication line, and a commodity sale site provided by a commodity sale enterprise is displayed on a display by a Web browser.

For example, in the case where a commodity is a personal computer, all types of personal computer to be sold are displayed as a table in a sales site. In the table, in addition to the name, type, and price of each personal computer, principal specifications such as a type of CPU provided in each personal computer, a memory capacity, a hard disk capacity, a type of display, presence or absence of CD-ROM (or DVD-ROM drive), a type of pre-installed software, and the like are displayed. Furthermore, a detailed button is displayed in each personal computer on a table screen, and an external appearance of a selected personal computer or a further detailed specification is displayed as a detailed screen by clicking the button. The user looks at the table screen and detailed screen, while comparatively discussing specifications of each personal computer, to select a desired personal computer.

However, in the case where a commodity is a personal computer, it is hard for a user to understand displayed specifications and there is a case where a user's readiness to do (object of use) cannot correspond to the specification of the personal computer. In such the case, it becomes necessary that the user goes out to a shop to ask a store clerk, or references to a catalog, etc., so that the user cannot readily select the commodity.

Furthermore, in the case where the user desires to purchase an accessory commodity of a main unit commodity such as a peripheral device connected to a personal computer main unit, etc. in a sales site of Internet, the user judges by an operation confirmation table indicating whether or not it is a peripheral device which normally operates when connecting it to the personal computer main unit. Then, the user has to select the accessory commodity. For this reason, the user separately references to the operation confirmation table provided in another site on Internet, and the user per se has to confirm operation of the accessory commodity, which is troublesome. Furthermore, as the user per se judges, there is a fear that the user erroneously purchases the peripheral device which is not confirmed the operation. Furthermore, for the user which has no confidence in judging by seeing the operation confirmation table, it is difficult to sell the peripheral devices via Internet.

Furthermore, it takes a lot of time that the user searches a desired commodity from among a plurality of commodities displayed in the table.

### SUMMARY OF THE INVENTION

It is therefore an object of the present invention to provide such a method and device that a user can readily select a commodity in a commodity sale in Internet.

It is another object of the present invention to provide a method and device capable of selecting readily an accessory commodity of a main unit commodity.

In order to attain the above objects, in the present invention, in a commodity sale via Internet, commodities to be sold are retrieved based on a object of use of the commodity. The commodities meeting retrieval conditions are displayed at Internet terminal. Thus, it is easy for a user to select the commodity. Furthermore, in the case where the user selects an accessory commodity which is connected to a main unit commodity, the accessory commodity which is confirmed to operate with respect to the main unit commodity is displayed in Internet terminal. Thus, it becomes easy for the user to select the commodity. Furthermore, it is feasible for the user to purchase erroneously the accessory commodity which is not adapted for the main unit commodity. Furthermore, the commodity for sale is retrieved based on a specification of the commodity. This also makes it easy to select the commodity.

According to a first aspect of the present invention, to achieve the above objects, there is provided a commodity retrieval method for retrieving a desired commodity, the method comprising the steps of displaying items for a plurality of objects of use of commodities; retrieving the commodities based on at least one object of use selected from the items; and displaying, on a terminal, information on a commodity having specifications corresponding to the selected object of use.

Preferably, the method further comprises the steps of preparing in advance a table indicative of correlation between the objects of use and specifications required to attain them; acquiring specifications corresponding to the selected object of use from the table; and retrieving a commodity using the acquired specifications as retrieval conditions.

According to a second aspect of the present invention, to achieve the above objects, there is provided a commodity retrieval method for retrieving a desired accessory commodity pertaining to a main unit commodity, the method comprising the steps of preparing in advance a table indicative of correlation between main unit commodities and the accessory commodities connectable thereto; retrieving the table on the basis of a specified main unit commodity; and displaying information on an accessory commodity connectable to the specified main unit commodity.

An apparatus for carrying out the above methods is also provided.

### BRIEF DESCRIPTION OF THE DRAWINGS

FIG. 1 is a diagram showing a structural example of a computer network according to an embodiment of the present invention;

FIG. 2 is a diagram showing a structural example of a server 10;

FIG. 3 is a flowchart of a first commodity selection process according to the present invention in the server 10;

FIG. 4 is a screen example displayed at a terminal 20 in the first selection process;

FIG. 5 is a screen example displayed at the terminal 20 in the first selection process;

FIG. 6 is a screen example displayed at the terminal 20 in the first selection process;

FIG. 7 is a screen example displayed at the terminal 20 in the first selection process;

FIG. 8 is a screen example displayed at the terminal 20 in the first selection process;

FIG. 9 is a screen example displayed at the terminal 20 in the first selection process;

FIG. 10 is a screen example displayed at the terminal 20 in the first selection process;

FIG. 11 is a screen example displayed at the terminal 20 in the first selection process;

FIG. 12 is an example of a object of use—specification correlation table;

FIG. 13 is a flowchart of a second commodity selection process according to the present invention;

FIG. 14 is a screen example displayed at the terminal 20 in the second selection process;

FIG. 15 is a screen example displayed at the terminal 20 in the second selection process;

FIG. 16 is a screen example displayed at the terminal 20 in the second selection process;

FIG. 17 is a screen example displayed at the terminal 20 in the second selection process; and

FIG. 18 is an example of an operation confirmation table.

### DESCRIPTION OF THE PREFERRED EMBODIMENT

Presently preferred embodiments of the present invention will now be described. However, a technical scope in the present invention is not limited to the embodiments of the present invention. In the embodiments of the present invention, as commodities to be sold in Internet, a personal computer as a main unit commodity, and peripheral commodities as the accessory commodities (a printer, a memory, a hard disk unit, an auxiliary memory unit (for example, a MO drive, a DVD-ROM drive) etc.) will be described as samples.

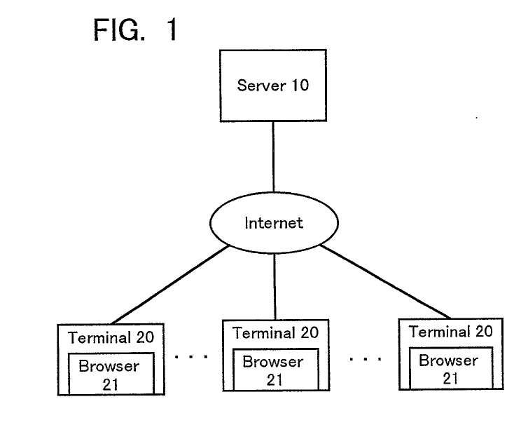

FIG. 1 is a diagram showing a structural example of a computer network according to the embodiments of the present invention. In FIG. 1, a server 10 and a plurality of client terminals 20 are connected to Internet through a communication line. The server 10 is a server providing Internet sales site according to the embodiment of the present invention, and stores a HTML file for the site, and various programs, databases, and the like described below. Each terminal 20 is, for example, a personal computer of a user, which comprises a control unit constituted by a CPU, etc., a display unit such as a CRT display, a liquid crystal display, or the like, and an input unit such as a key board, a mouse, or the like. Furthermore, the HTML file is acquired from the server 10, and a browser 21 for displaying it on a screen is installed.

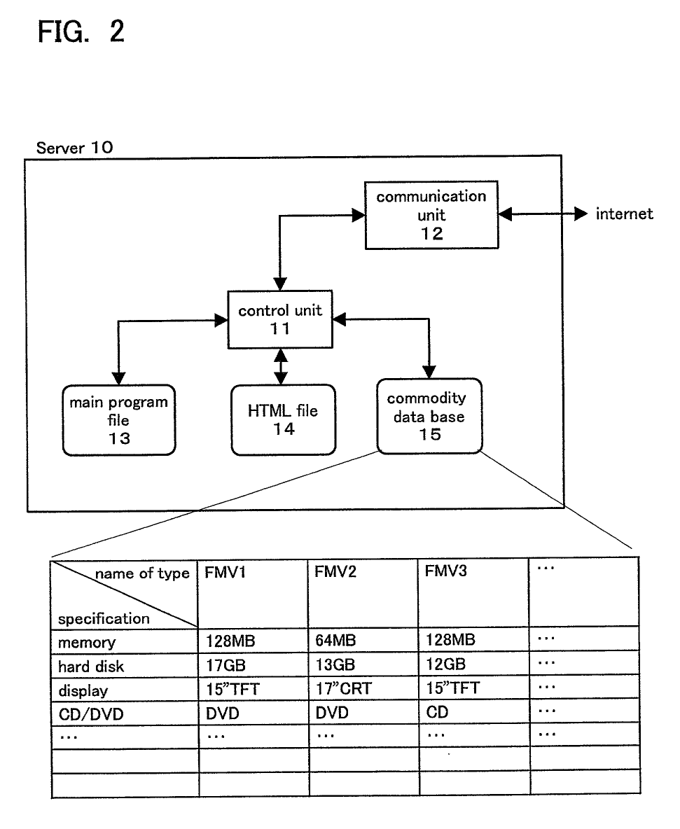

FIG. 2 is a diagram showing a structural example of the server 10. A control unit 11 is constituted by a CPU, etc. The control unit 11 controls a readout of a file, controls a transfer of a file, controls each unit in the server 10, retrieves a database, processes various operations, or the like. A communication unit 12 controls a transmission and reception of a file. For example, the communication unit 12 receives data from the terminal 20, and transfers them to the control unit 11, and further transmits the file transferred from the control unit 11 to the terminal 20. Furthermore, the below file is stored in a predetermined memory unit.

A HTML file 13 is a plurality of files constituting Internet sales site, and is described in a HTML (HyperText Markup Language) language.

A main program file 14 has a program for reading out the HTML file to transfer it to the terminal 20, a program for processing data from the terminal 20, a program for retrieving the database, a program for embedding the retrieved results in the HTML file, and the like.

A commodity database 15 stores a plurality of pieces of attribute information in response to all commodities to be sold. For example, in the case where the commodity is a personal computer, the attribute information denotes a price, type (desktop type or notebook type), and various specifications of the personal computer. The specification denotes a type of the CPU, a capacity of the memory, a capacity of the hard disk, a type of the display, presence or absence of a CD-ROM drive or a DVD-ROM drive, or the like).

According to a first embodiment of the present invention, the server 10 retrieves a commodity from a plurality of commodities within the commodity database 15 based on a specification of the commodity selected at the terminal 20, and displays the commodity having the selected specification at the terminal 20. Furthermore, the server 10 retrieves the commodity based on a object of use of the commodity selected at the terminal 20, and displays the commodity having the specification which can attain the selected object of use at the terminal 20.

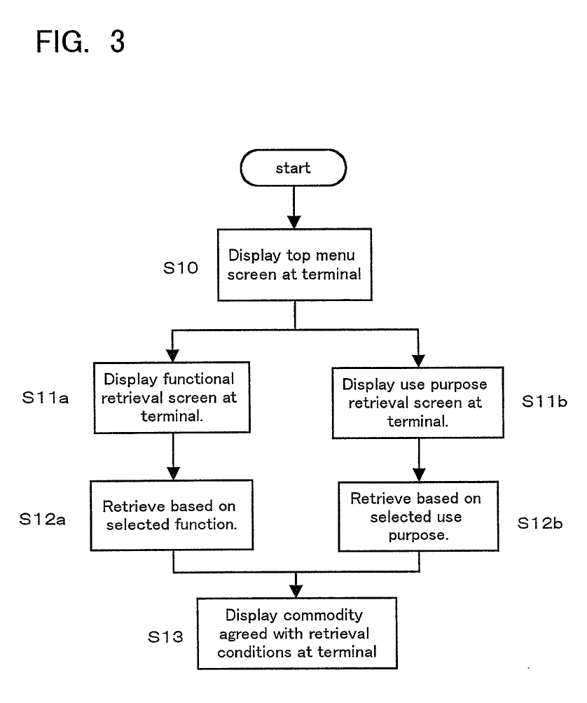

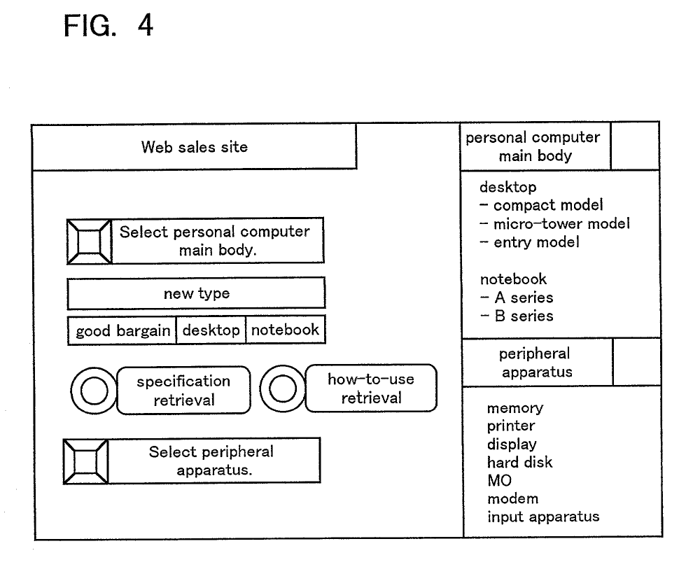

FIG. 3 is a flowchart of a first commodity selecting process according to the present invention. FIGS. 4 to 11 are examples of screens to be displayed at the terminal 20 in response to each step. With reference to FIGS. 4 to 11, FIG. 3 will be explained.

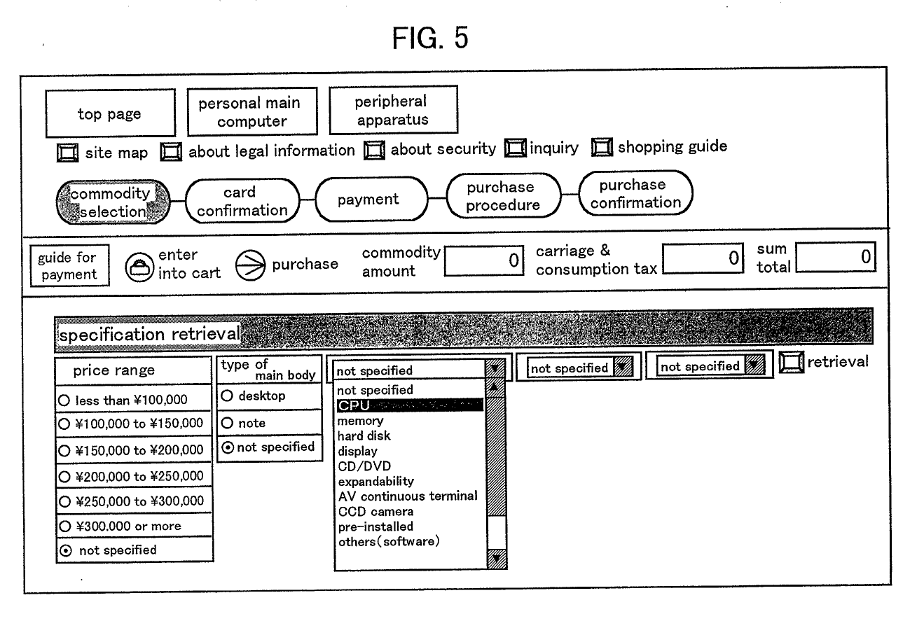

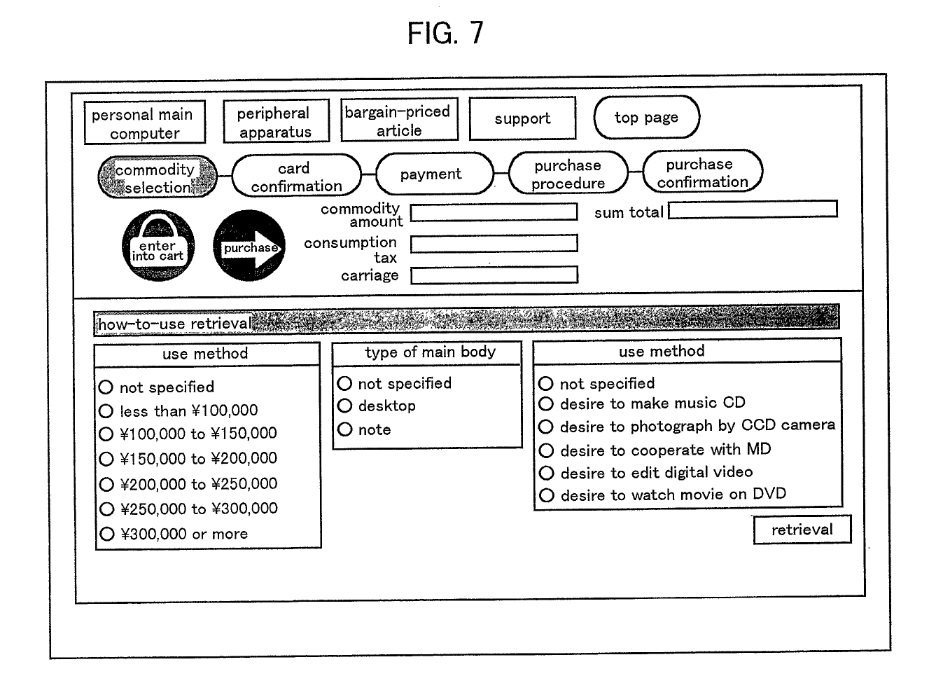

In FIG. 3, first, the server 10 corresponds to access operation to a sales site at the terminal 20, and transmits the HTML file in response to a top menu screen shown in FIG. 4 to the terminal 20, and displays the top menu screen at the terminal 20 (S10). Continuously, in response to selection operation of “specification Retrieval” or “How-to-Use Retrieval” in the top menu screen at the terminal 20, the server 10 displays any one of a specification retrieval screen (FIG. 5) and a object of use retrieval screen (FIG. 7) (S11a, S11b). A retrieval screen of FIG. 5 is a screen for a user's selecting the specification of the commodity. The server 10 corresponds to the selection operation of the specification at the terminal 20, and retrieves the commodity database 15 based on the selected specification (S12a). Furthermore, a retrieval screen of FIG. 7 is a screen for selecting the object of use of the commodity. The server 10 corresponds to the selection operation of the object of use at the terminal 20, and retrieves the commodity database 15 based on the selected object of use (S12b).

In FIG. 5, the user operates the terminal 20, and checks at least one of respective check boxes of a plurality of price ranges and types displayed from retrieval items of “Price Range” and “Type”. Furthermore, the user can select three specification items that the user desires to retrieve. The number of specification items which can be selected is arbitrary. When the user clicks a button in a specification item specifying column, a specification menu shown in FIG. 5 is displayed. When the user clicks a specification item that the user desires to retrieve, the selected specification item is displayed, and the corresponding choice is displayed. The specification items are, as illustrated, “CPU” (a type of the CPU), “Memory” (a capacity of the memory), “Hard disk” (a capacity of the hard disk), “Display” (a type of the display), “CD/DVD” (presence or absence of the CD-ROM drive or DVD-ROM drive), “Extension” (a type and the number of an extended slot), “AV linkage terminal” (presence or absence of a MD linking optical terminal, a digital video editing IEEE terminal, etc.), “CCD camera” (presence or absence of integration of a CCD camera), “Pre-installed” (a main type of a pre-installed software (a word processor, a spread sheet software)), “Other Software” (a pre-installed software other than the word processor and spread sheet software), and the like.

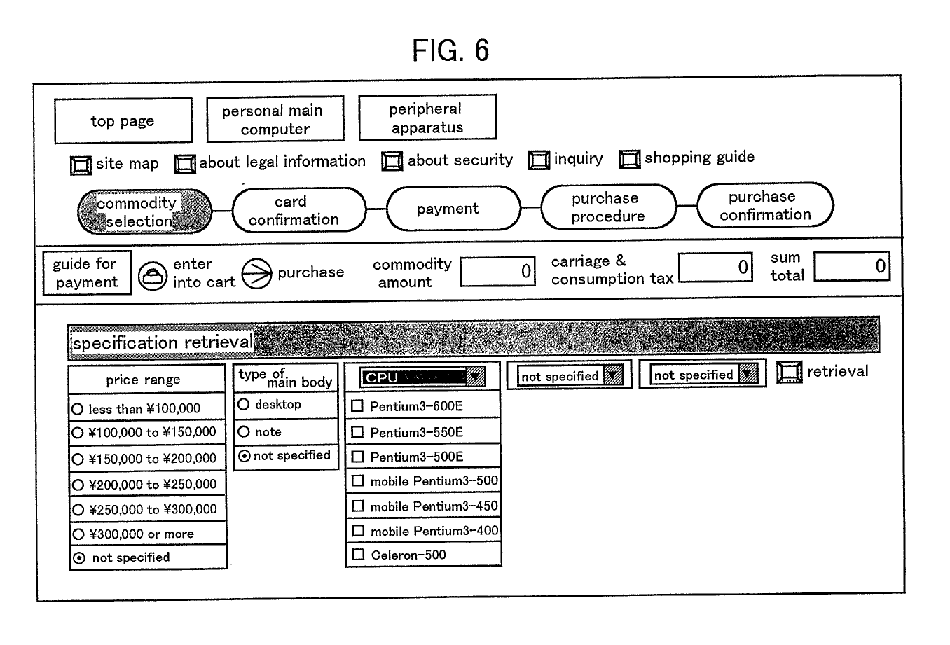

FIG. 6 is an example of a screen in the case where the specification item “CPU” is selected in one specification item specifying column. When “CPU” is selected as the specification item, as illustrated, all the types of CPU of the personal computer which is dealt in the sales site are displayed. The user checks at least one of the check boxes of the type of CPU that the user desires.

The plurality of specification item specifying columns are formed, and the plurality of specification items can be set as retrieval conditions. When each specification item specifying column is clicked, the specification menu shown in FIG. 5 is displayed and the corresponding choice is displayed.

In this manner, according to the embodiment of the present invention, at least one of the plurality of specifications provided in all commodities which are dealt is set as the retrieval condition. Accordingly, the user can retrieve quickly the commodity having the desired specification.

When a “Retrieval” button displayed in FIG. 6 is clicked, the server 10 retrieves the commodity database 15 with the selected specification as the retrieval conditions. In the commodity database 15 shown in FIG. 2, the following two retrieval examples are shown:

### RETRIEVAL EXAMPLE 1

```
Retrieval Conditions
      specification item “Memory”
            Choice “128 MB”
                “64 MB”
                “128 MB” is selected out of “32 MB.”
Retrieval Results
      FMV 1
      FMV 3
```

### RETRIEVAL EXAMPLE 2

```
Retrieval Conditions
      specification item “Memory”
            Choice “128 MB”
                “64 MB”
                “128 MB” is selected out of “32 MB.”
      specification item “CD/DVD”
            Choice “DVD-ROM”
                “CD-ROM”
                “DVD-ROM” is selected out of “CD-R.”
Retrieval Results
      FMV 1
```

Then, in the case of the selection by “How-to-Use Retrieval,” in FIG. 7, the user operates the terminal 20 in the same manner as in FIG. 5, the user checks at least one check box in each of the plurality of price ranges and types displayed from the retrieval items of “Price Range” and “Type.” Furthermore, the user checks at least one of the check boxes of the how-to-use that the user desires, from the retrieval items of “How to Use” (object of use).

“How to Use” is, for example, “Desire to Make Music CD,” “Desire to Photograph by CCD Camera,” “Desire to Link with MD,” “Desire to edit Digital Video,” or “Desire to Watch Movie by DVD,” and this is what the user desires to do specifically by using a commodity. For the purpose of the respective above use methods, the necessary specification of the commodity is as follows: For example, in the case of “Desire to Make Music CD,” this is provided with the CD-R drive as the specification of the commodity, and it is necessary that a music composing software is installed. Furthermore, in the case of “Desire to Photograph by CCD Camera,” it is necessary that the CCD camera is integrated (or annexed). In the case of “Desire to Link with MD,” it is necessary that this is provided with an optical terminal for connecting with a MD (Mini Disk) player/recorder. In the case of “Desire to Edit Digital Video,” it is necessary that this is provided with an IEEE interface for connecting with the digital video. Furthermore, in the case of “Desire to Watch Movie by DVD,” it becomes necessary that this is provided with the DVD-ROM drive. The commodity database 15 stores a object of use—specification correlation table for corresponding the set “How-to-Use” (object of use) to the commodity specification required therefor.

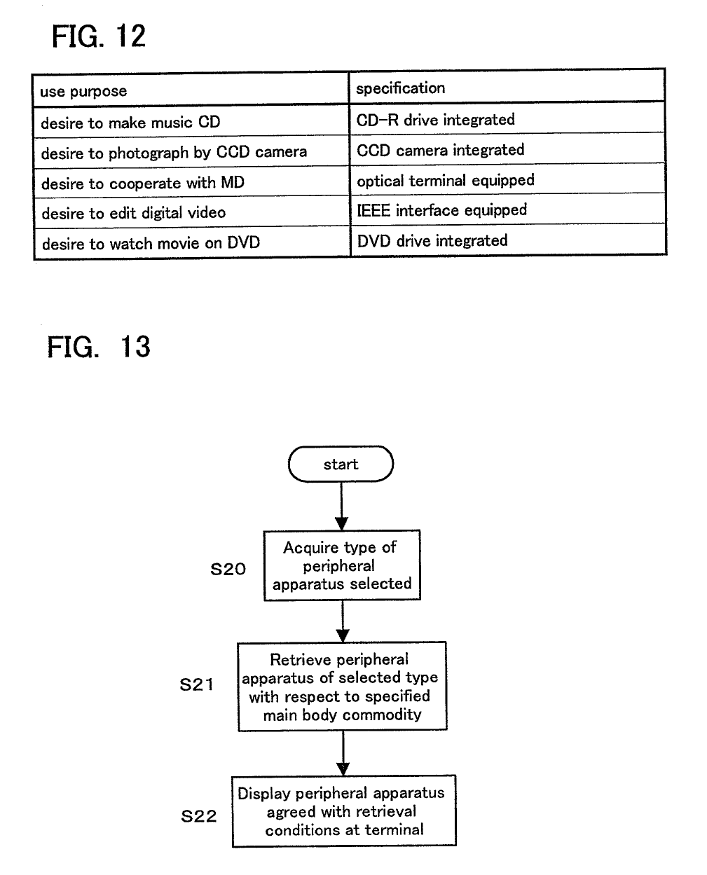

FIG. 12 is an example of the object of use—specification correlation table. The object of use corresponds to the necessary specification for each use method. Incidentally, in the case where the object of use is “Desire to Make Music CD,” the two specifications of the integration of the CD-R drive and the installation of the music software are necessary, and in the case where two specifications are set in commodity design, it can be deemed that these two specifications are a single specification. Accordingly, in the correlation table, as the specification in response to the object of use “Desire to Make Music CD,” for example, it is enough that the object of use corresponds to only the specification “Integration of CD-R”. Of course, in the case where a plurality of the specifications are required for a certain object of use, and their specifications are not set in commodity design, it is necessary that a plurality of the object of uses correspond to a single object of use.

When the “Retrieval” button displayed in FIG. 7 is clicked, the server 10 acquires the aforesaid specification required for executing the specified use method from the correlation table of FIG. 12, and retrieves the commodity database 15 based on the acquired specification.

In this manner, according to the embodiment of the present invention, even in the case where the user forgets the specification corresponding to what the user desires to do, the user specifies a desire (object of use), so that the user can find the commodity having the specification required for the object of use.

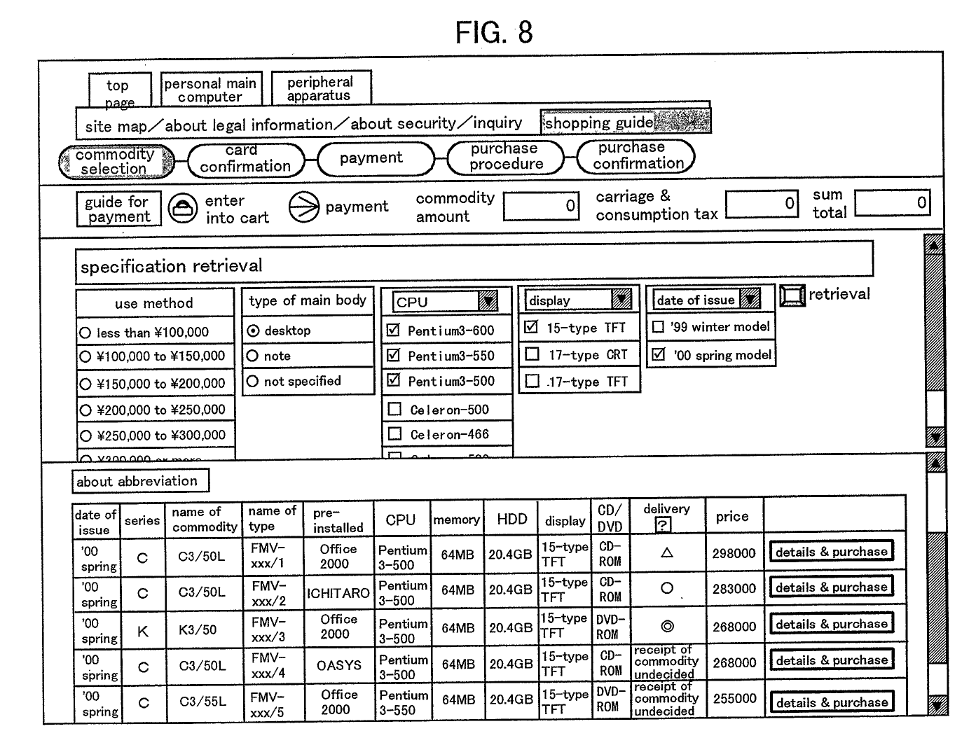

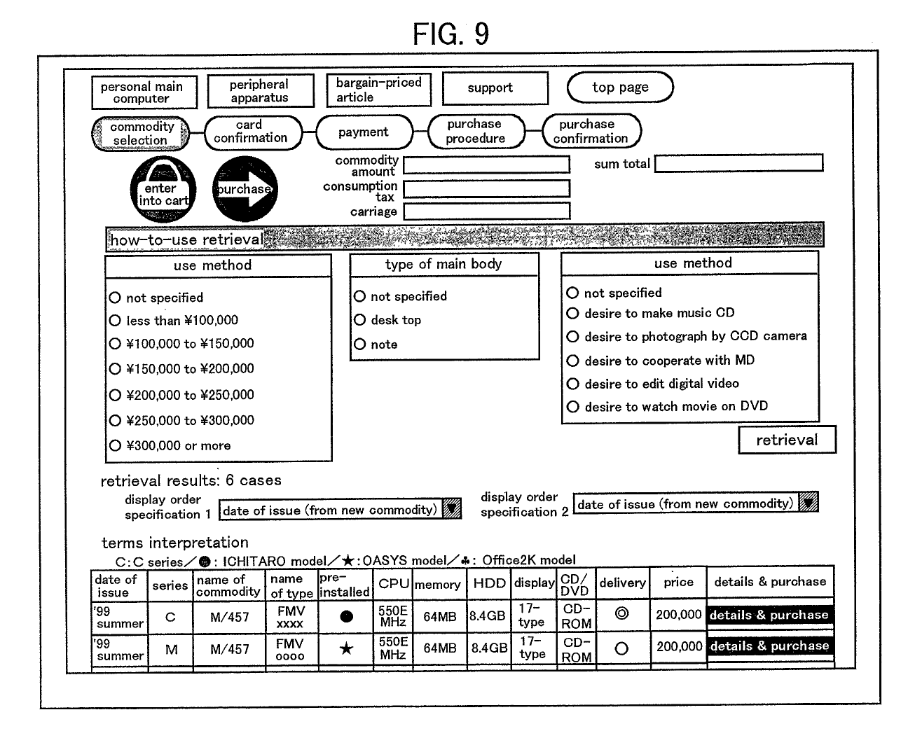

The server 10 converts the commodity data agreeing with the retrieval conditions into the HTML file, and transmits it to the terminal 20, and displays it on the screen (S13). FIG. 8 is an example of a screen on the retrieval results in response to FIG. 6. Incidentally, in FIG. 8, in the case where “Display” and “Introductory Time” are set as retrieval conditions other than “CPU” as specification items, the retrieval results are displayed. Furthermore, FIG. 9 is an example of a screen of the retrieval results in response to FIG. 7.

In FIG. 8 or 9, a list of the title of the commodity extracted by a retrieval, an outline of the specifications, and the like is displayed in an approximately lower half part of the screen as the retrieval results. Specifically, as shown in the drawings, the introductory time of each commodity, the name of series, the name of commodities, the name of types, main pre-installed software, the type of CPU, the capacity of memory, the capacity of hard disk, the type of display, presence or absence of CD-ROM or DVD-ROM drive, or the like.

In this manner, as only the commodity having the specification that the user desires or only the commodity that is applicable to what the user desires is displayed from all the commodities, the user can find readily the desired commodity from among the plurality of commodities.

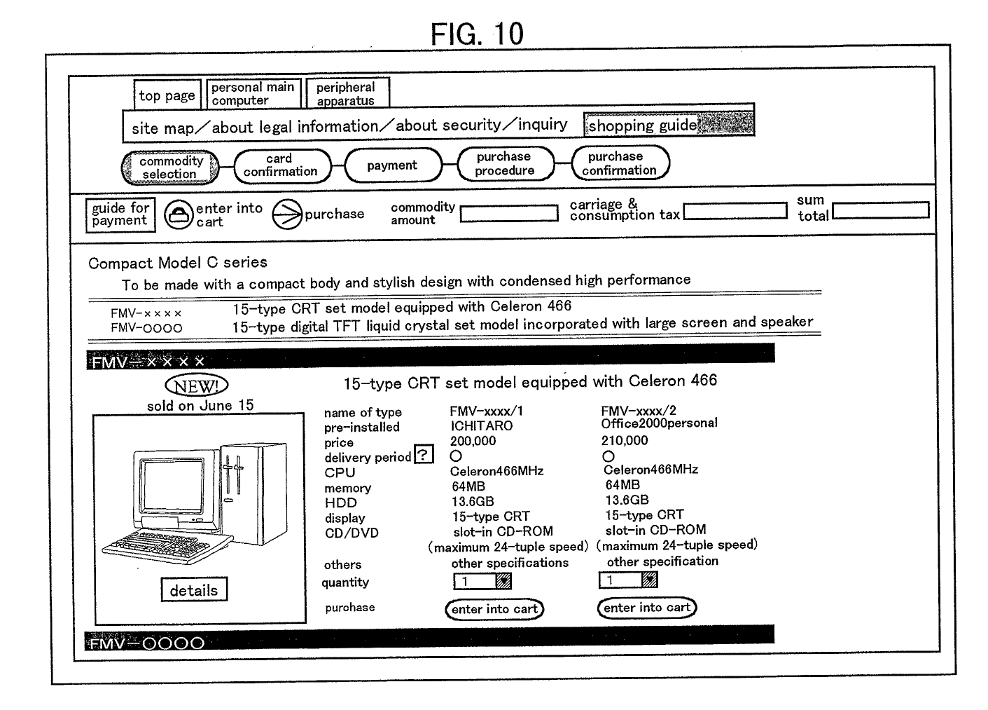

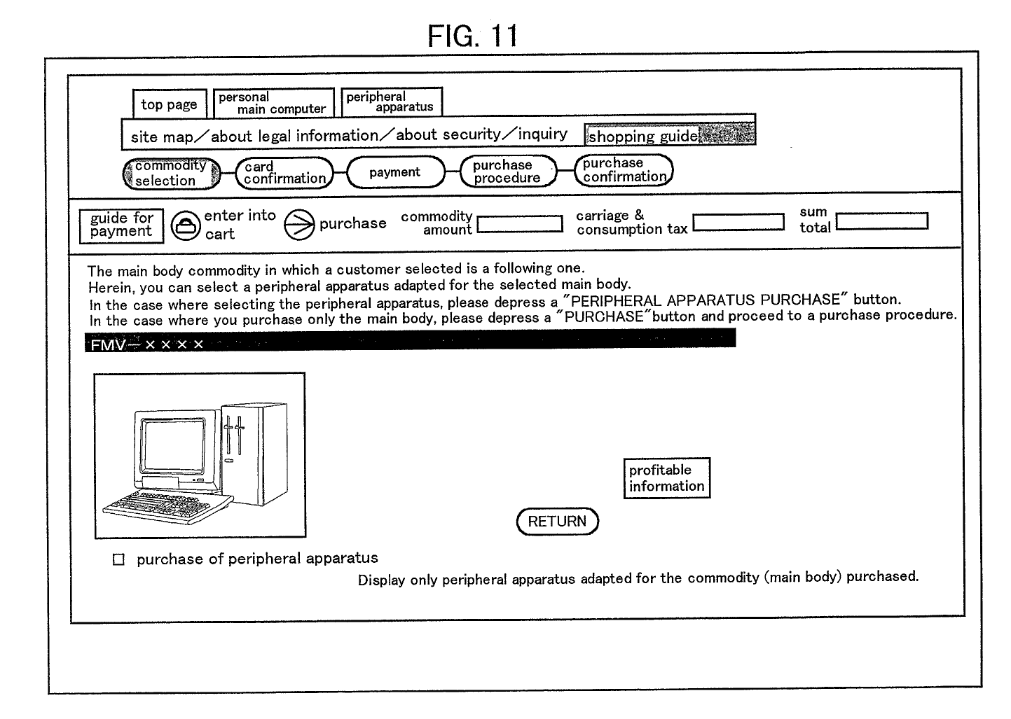

Hereinafter, when the user clicks “Details and Purchase” of the desired commodity from a list of the retrieval results of the screen, the server 10 displays the purchase screen of FIG. 10 at the terminal 20 based on the operation. In FIG. 10, the user inputs the quantity of purchase and clicks “Enter it into Cart”. In response to this operation, the server 10 stores temporally the commodity data in response to the selected commodity in an order receiving file (cart file) (not shown), and also displays a purchase confirmation screen of FIG. 11 at the terminal 20. In FIG. 11, the user clicks “Purchase”, whereby the server 10 moves the commodity data stored in the order receiving file in a purchase file (not shown). Thus, the purchase is confirmed and an already-known purchase procedure is executed.

A second embodiment of the present invention will then be described. According to the second embodiment, in the case where the user purchases an accessory commodity (peripheral device) of a main unit commodity (personal computer) in Internet sales site, the server 10 retrieves based on a predetermined operation confirmation table from a plurality of the accessory commodities, and displays the accessory commodity at the terminal 20 which has been confirmed the operation with respect to the main unit commodity which has been in advance specified. The accessory commodities are, for example, a further installed memory of a personal computer, a scanner, a printer, an auxiliary memory unit (an externally installed hard disk, an integrated hard disk, a MD drive, or the like), a communication unit (TA, a modem), or the like.

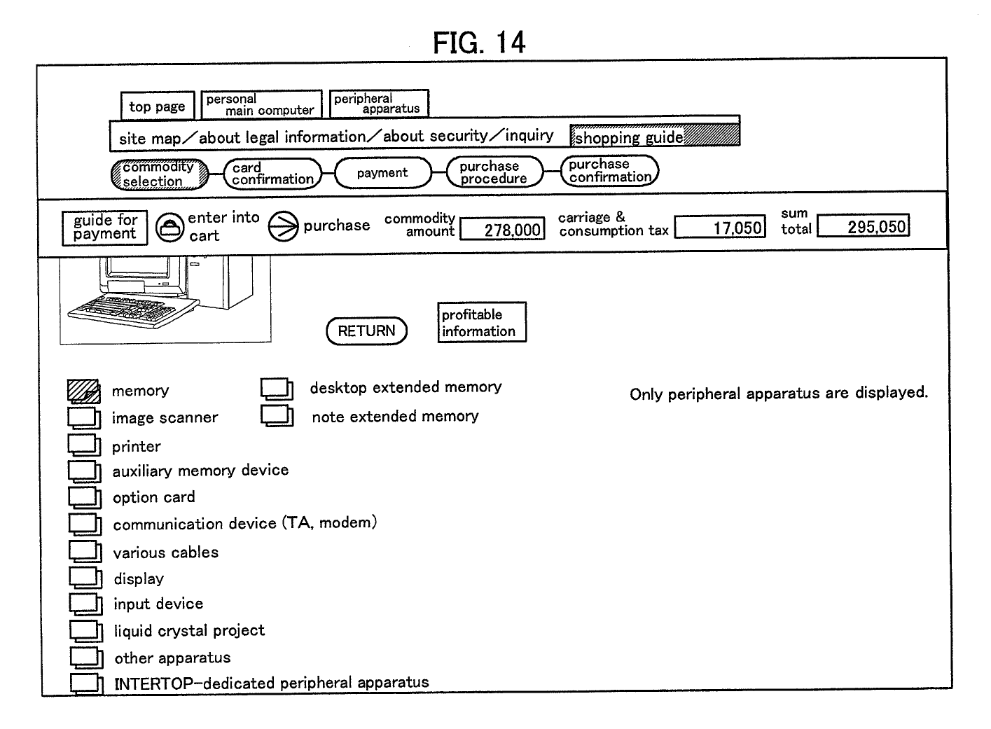

FIG. 13 is a flowchart of a second commodity selection process according to the present invention, and FIGS. 14 to 21 are examples of a screen displayed at the terminal 20 in response to each step. With reference to FIGS. 14 to 21, FIG. 13 will be explained. Incidentally, in the below description, the case where the accessory commodities in response to the main unit commodity selected and purchased in the aforesaid first commodity selection process are purchased will be explained.

After the main unit commodity to be purchased is specified, when “Purchase of Peripheral Device” is clicked in a screen of FIG. 11 illustrated above, as shown in FIG. 14, a large item menu and middle item menu of the peripheral device are displayed. Here, assume that the user selects a not-shown middle item “Ink-Jet Printer” out of the large item “Printer.”

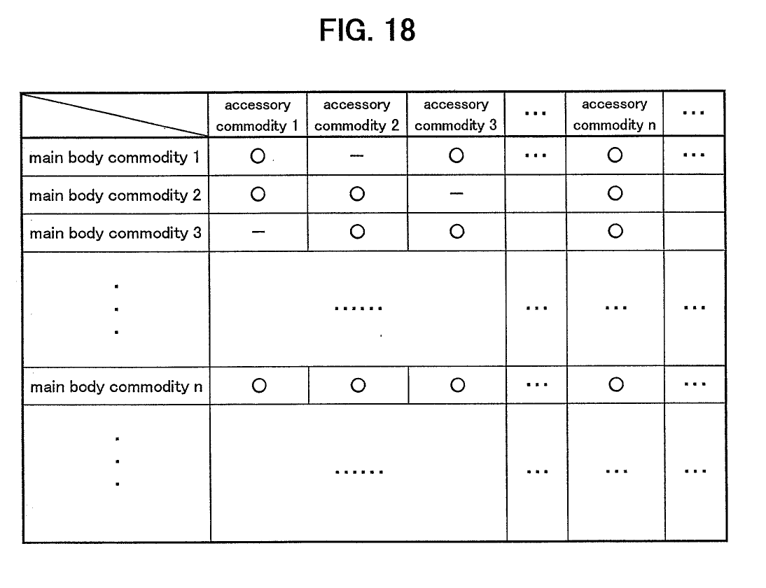

When the type of the peripheral device is selected at the terminal 20 (S20), the server 10 references to the operation confirmation table integrated previously, and retrieves the peripheral device which has been confirmed the operation with respect to the main unit commodity specified (S21). FIG. 18 shows an example of the operation confirmation table.

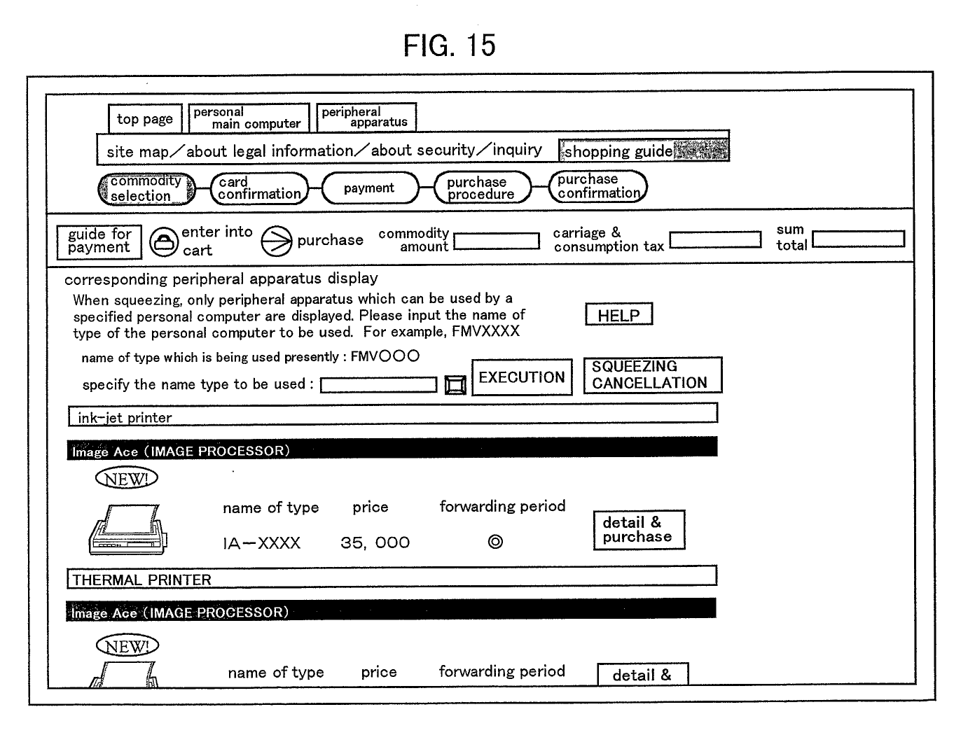

The server 10 converts the commodity data in response to the peripheral device agreeing with the retrieval conditions into the HTML file, and transmits it to the terminal 20, and displays it on the screen (S22). FIG. 15 is an example of a screen of the retrieval results. In FIG. 15, as the retrieval results, a list of the name, type, price, and the like of the peripheral device which have been extracted by the retrieval is displayed in an approximately half part of the screen.

In this manner, according to the second embodiment of the present invention, as only the accessory commodity which has been confirmed the operation with respect to the specified main unit commodity is displayed from among a plurality of the accessory commodities (peripheral devices) registered in the commodity database 15, the user can find the accessory commodity which is connectable to the main unit commodity easily. Furthermore, it is possible to prevent the user from selecting the accessory commodity which does not operate in the main unit commodity specified erroneously.

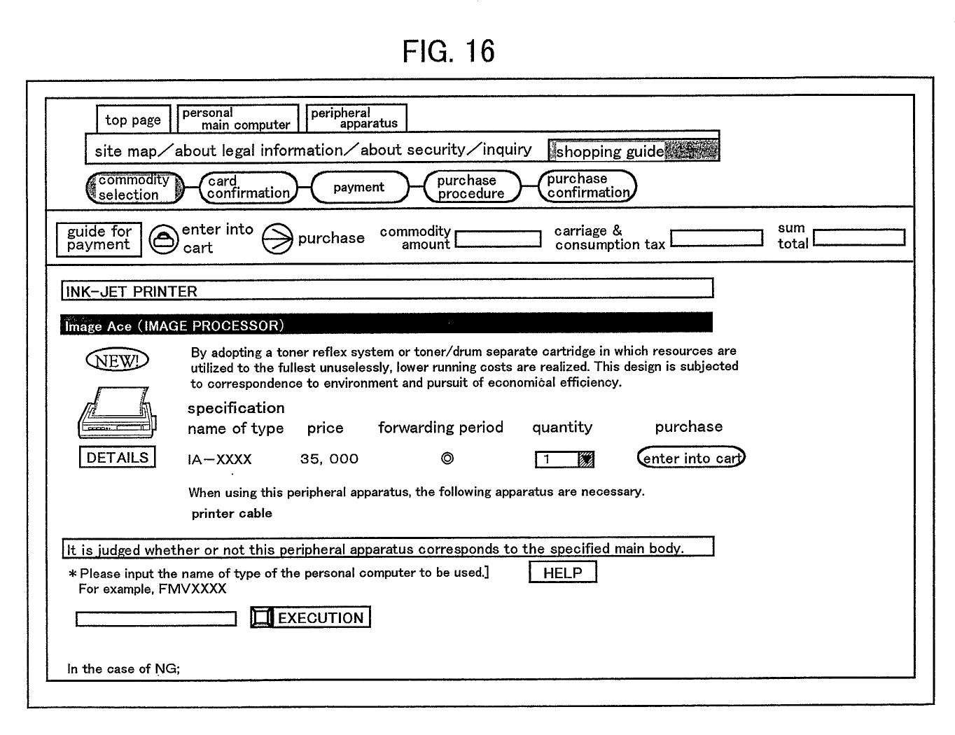

Hereinafter, the purchase procedure is same as above. Namely, when the user clicks “Details and Purchase” of the desired commodity from the list of the retrieval results of the screen of FIG. 15, the server 10 displays the purchase screen shown in FIG. 16 at the terminal 20 in response to the operation. In FIG. 16, after the user inputs the quantity of purchase, the user clicks “Enter it into Cart.” In response to this operation, the server 10 stores temporally the commodity data corresponding to the selected commodity in the order receiving file (cart file). Furthermore, in FIG. 16, based on the user's click of a “Purchase” button, the server 10 moves the commodity data stored in the order receiving file to the purchase file. Thus, the purchase is confirmed and the server 10 displays a payment screen (not shown) that the user inputs a payment method and the like, at the terminal 20.

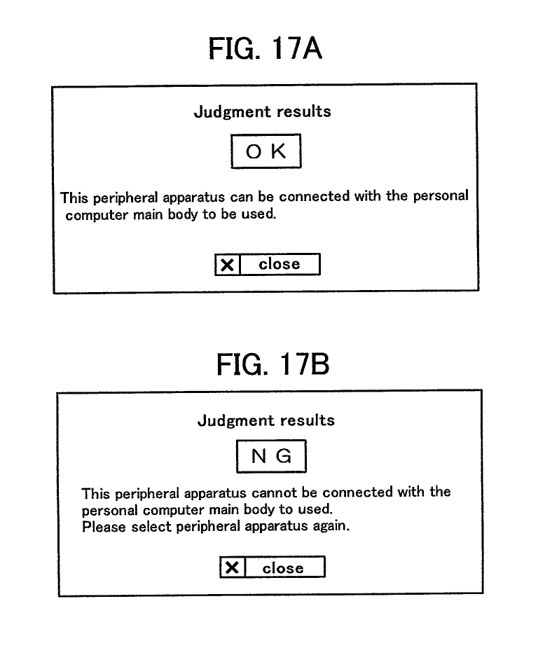

Incidentally, the user can examine whether or not the retrieved peripheral device is connectable to even another main unit commodity on the screen of FIG. 16. The user inputs a type of a predetermined main unit commodity in an input column under “Judge whether or not this is a peripheral device corresponding to a specified main unit” on the screen of FIG. 17, and clicks an “Execution” button. In response to this operation, the server 10 references to the operation confirmation table of FIG. 18, and judges whether or not the selected peripheral device is confirmed the operation with respect to the input main unit commodity.

In the case where the operation is confirmed, “Judgement Results OK” shown in FIG. 17(a) is displayed overlapped on the screen of FIG. 16. In the case where the operation is not confirmed, “Judgement Results NG” shown in FIG. 17(b) is displayed overlapped on the screen of FIG. 16.

According to this embodiment, first, the main unit commodity to be purchased is specified and the peripheral device adaptable for the specified main unit commodity is displayed, and the present invention is not limited thereto. The embodiment may be structured so that, merely, the user inputs identification information for specifying the main unit commodity such as a name of type, and the like, so that the peripheral device corresponding to the main unit commodity indicated by the identification information is displayed. However, according to the aforesaid embodiment, since the user does not input the identification information of the main unit commodity, it is possible to prevent the user from error-inputting the identification information.

Hereinbefore, according to the present invention, in the commodity sale via Internet, the commodity for sale is retrieved based on the object of use of the commodity. The commodity meeting the retrieval conditions is displayed at Internet terminal. Thus, the user is easy to select the commodity. Furthermore, in the case where the user selects the accessory commodity to be connected to the main unit commodity, the accessory commodity which has been confirmed the operation with respect to the main unit commodity is displayed at Internet terminal. Thus, the user is easy to select the commodity. Furthermore, it is possible to prevent the user from error-purchasing the accessory commodity which is not adapted for the main unit commodity. Furthermore, the commodity for sale is retrieved based on the commodity specification. Thus also, it becomes easy to select the commodity.

A protective scope of the present invention is not limited to the aforesaid embodiments, and extends to the present invention mentioned in the claim for a patent and the equivalents.

What is claimed is:

1. A commodity retrieval method for retrieving a desired commodity, comprising the steps of:
displaying items for a plurality of objects of use of commodities;
retrieving the commodities based on at least one object of use selected from the items; and
displaying information on a commodity having specifications corresponding to the selected object of use.

2. The commodity retrieval method according to claim 1, further comprising the steps of:
preparing in advance a table indicative of correlation between the objects of use and specifications required to attain them;
acquiring specifications corresponding to the selected object of use from the table; and
retrieving a commodity using the acquired specifications as retrieval conditions.

3. A commodity retrieval method in a commodity sale transaction via a network, the method comprising the steps of:
displaying items for a plurality of objects of use of commodities on a user's terminal;
retrieving the commodities based on at least one object of use selected by the terminal; and
displaying, on the terminal, information on a commodity having specifications corresponding to the selected object of use.

4. The commodity retrieval method according to claim 3, wherein the network is Internet.

5. The commodity retrieval method according to claim 3, further comprising the steps of:
preparing in advance a table indicative of correlation between the objects of use and specifications required to attain them;
acquiring specifications corresponding to the selected object of use from the table; and
retrieving a commodity for sale using the acquired specifications as retrieval conditions.

6. A commodity retrieval method for retrieving a desired accessory commodity pertaining to a main unit commodity, the method comprising the steps of:
preparing in advance a table indicative of correlation between main unit commodities and the accessory commodities connectable thereto;
retrieving the table on the basis of a specified main unit commodity; and
displaying information on an accessory commodity connectable to the specified main unit commodity.

7. The commodity retrieval method according to claim 6, wherein the accessory commodity connectable to the main unit commodity is one whose operation upon connection to the main unit commodity has already been verified.

8. A commodity retrieval method for retrieving an accessory commodity attendant on a main unit commodity that is sold by way of a network, the method comprising the steps of:
preparing in advance a table indicative of correlation between main unit commodities and accessory commodities connectable thereto;
retrieving the table on the basis of a main unit commodity selected by a user's terminal; and
displaying, on the terminal, information on an accessory commodity connectable to the selected main unit commodity.

9. The commodity retrieval method according to claim 8, wherein the accessory commodity connectable to the main unit commodity is one whose operation upon connection to the main unit commodity has already been verified.

10. The commodity retrieval method according to claim 8, wherein the main unit commodity is a personal computer, and wherein the accessory commodity includes at least one of peripheral devices such as a memory, a scanner, a printer, an auxiliary memory unit and a communication unit.

11. The commodity retrieval method according to claim 8, wherein the network is Internet.

12. A computer apparatus acting as a server that provides a commodity sale transaction site on Internet, the computer apparatus executing a transaction with an Internet terminal by way of Internet, the apparatus comprising:
a database of a commodity for sale;
a retrieval unit for retrieving the database on the basis of at least one object of use of the commodity for sale, selected by the terminal; and
a communication unit for transmitting data on a commodity having specifications corresponding to the selected object of use to the terminal.

13. A computer apparatus acting as a server that provides a commodity sale transaction site for selling main unit commodities and accessory commodities associated therewith, the computer apparatus executing a transaction with an Internet terminal by way of Internet, the apparatus comprising:
a storage unit for storing a table indicative of correlation between the main unit commodities and the accessory commodities whose operations upon connection to the main unit commodities have already been verified;
a retrieval unit for retrieving the table from a main unit commodity selected by the terminal; and
a communication unit for transmitting to the terminal data on the accessory commodities whose operations for the selected main unit have already been verified.

14. A computer apparatus acting as a client terminal on Internet and executing a transaction via Internet with a server that provides a commodity sale transaction site on Internet, the computer apparatus comprising:
a communication unit for transmitting to the server at least one piece of object of use data on a commodity selected by selecting operation, the communication unit receiving from the server data on a commodity having specifications corresponding to the selected object of use; and
a display unit for displaying the received commodity data.

15. A computer apparatus acting as a client terminal on Internet and executing a transaction via Internet with a server that provides a commodity sale transaction site for selling main unit commodities and accessory commodity associated therewith on Internet, the computer apparatus comprising:
a communication unit for transmitting to the server data on a main unit commodity selected by selecting operation, the communication unit receiving data on accessory commodities whose operations upon connection to the selected main unit commodity have already been verified; and
a display unit for displaying the received data on the accessory commodities.

16. A computer program product allowing a computer that executes a commodity sale transaction with a user's terminal by way of a network
to display objects of use of commodities for sale on the terminal;
to retrieve a database of the commodities for sale on the basis of at least one object of use selected by the terminal; and
to transmit to the terminal data on a commodity having specifications corresponding to the selected object of use.

17. A computer program product allowing a computer that executes a commodity sale transaction with a user's terminal by way of a network
to specify a main unit commodity by the terminal;
to retrieve a correlation table on the basis of the main unit commodity specified by the terminal, the correlation table indicating correlation between main unit commodities and accessory commodities whose operations upon connection to the main unit commodities have already been verified; and
to transmit to the terminal data on accessory commodities whose operations for the specified main unit commodity have already been verified.

18. A computer apparatus acting as a server that provides a commodity sale transaction site on Internet, the computer apparatus executing a transaction with an Internet terminal by way of Internet, the apparatus comprising:
a database of a commodity for sale;
a retrieval unit for retrieving the database on the basis of at least one specification of the commodity for sale, selected by the terminal; and
a communication unit for transmitting data on a commodity having the selected specification to the terminal.

19. A computer program product allowing a computer that executes a commodity sale transaction with a user's terminal by way of a network
to display specifications of commodities for sale on the terminal;
to retrieve a database of the commodities for sale on the basis of at least one specification selected by the terminal; and
to transmit to the terminal data on a commodity having the selected specification.

20. A program storage device readable by a computer, tangibly embodying a program of instructions executable by the computer to perform method step for executing a commodity sale transaction with a user's terminal by way of a network, the method comprising the steps of:
causing to display objects of use of commodities for sale on the terminal;
retrieving a database of the commodities for sale on the basis of at least one object of use selected by the terminal; and
transmitting to the terminal data on a commodity having specifications corresponding to the selected object of use.

21. A program storage device readable by a computer, tangibly embodying a program of instructions executable by the computer to perform method step for executing a commodity sale transaction with a user's terminal by way of a network, the method comprising the steps of:
causing to specify a main unit commodity by the terminal;
retrieving a correlation table on the basis of the main unit commodity specified by the terminal, the correlation table indicating correlation between main unit commodities and accessory commodities whose operations upon connection to the main unit commodities have already been verified; and
transmitting to the terminal data on accessory commodities whose operations for the specified main unit commodity have already been verified.

22. A program storage device readable by a computer, tangibly embodying a program of instructions executable by the computer to perform method step for executing a commodity sale transaction with a user's terminal by way of a network, the method comprising the steps of:
causing to display specifications of commodities for sale on the terminal;
retrieving a database of the commodities for sale on the basis of at least one specification selected by the terminal; and
transmitting to the terminal data on a commodity having the selected specification.
